(19) United States
(12) Patent Application Publication
(10) Pub. No.: US 2021/0377755 A1
(43) Pub. Date: Dec. 2, 2021

(54) COMMUNICATION METHOD FOR SCENARIO WITH SECONDARY CELL GROUP FAILURE

(71) Applicant: JRD Communication (Shenzhen) LTD., Shenzhen (CN)

(72) Inventors: Yaming LUO, Shenzhen (CN); Xiang CHEN, Shenzhen (CN); Eddy CHIU, Shenzhen (CN)

(73) Assignee: JRD Communication (Shenzhen) LTD., Shenzhen (CN)

(21) Appl. No.: 16/759,449

(22) PCT Filed: Mar. 30, 2018
(86) PCT No.: PCT/CN2018/081362

§ 371 Date: Apr. 27, 2020

(30) Foreign Application Priority Data
Dec. 27, 2017 (CN) 201711450697.2

(51) Int. Cl. H04W 24/04; H04W 24/10; H04W 52/02; H04W 76/19

(52) U.S. Cl. CPC H04W 24/04; H04W 76/19; H04W 52/0258; H04W 24/10

(57) ABSTRACT

A communication method includes: determining by a user equipment whether an SCG failure occurs between the user equipment and an SCG; when the SCG failure occurs between the user equipment and the SCG, using, by the user equipment, a failure mode measurement configuration to perform measurement and/or reporting of a link quality between the user equipment and the SCG. In this way, when the SCG failure occurs between the user equipment and the SCG, the power/resources consumed before the user equipment finds a proper cell can be reduced. A user equipment, a communication node and an apparatus having a storage function are also provided.

### TECHNICAL FIELD

The present disclosure generally relates to communication technology, and in particular relates to a communication method for a scenario with a secondary cell group (SCG) failure.

### BACKGROUND

In a Multi-RAT Dual Connectivity (MR-DC) network, such as an E-UTRA-NR Dual Connectivity (EN-DC), when an SCG failure occurs, a user equipment (UE) may continue performing measurement and/or reporting on cells which can be detected by the UE, based on an old configuration of a secondary node (SN), so that the UE can find a proper new radio (NR) cell and establish communication connection with the proper NR cell in time. However, the measurement and/or reporting may cause a continual power/resource consumption of the UE when the UE cannot find the proper NR cell for a long time, thereby resulting in a waste of power/resource consumption.

### SUMMARY

The technical problem to be solved by the present disclosure is to provide a communication method for a scenario with an SCG failure, which may reduce the power/resources consumed before the UE finds a proper cell when the SCG failure occurs between the user equipment and the SCG.

In order to solve the above technical problem, a first aspect of the present disclosure provides a communication method. The method includes: determining, by a user equipment, whether an SCG failure occurs between the user equipment and an SCG; when the SCG failure occurs between the user equipment and the SCG, using, by the user equipment, a failure mode measurement configuration to perform measurement and/or reporting of a link quality between the user equipment and the SCG.

In order to solve the above technical problem, a second aspect of the present disclosure provides a communication method. The method includes: starting, by a secondary node, a timer when the secondary node receives content associated with the secondary node and comprised in SCG failure information from a master node; wherein the timer is configured to limit wait time for the secondary node to receive content associated with the secondary node and comprised in the event-triggered report from the master node; when the secondary node receives the content associated with the secondary node and comprised in the event-triggered report from the master node in a preset period of time, stopping the timer.

In order to solve the above technical problem, a third aspect of the present disclosure provides a user equipment. The user equipment includes a processor and a communication circuit; wherein the processor is coupled to the communication circuit, and configured to execute any communication method described above.

In order to solve the above technical problem, a fourth aspect of the present disclosure provides a communication node. The communication node includes: a processor and a communication circuit; wherein the processor is coupled to the communication circuit, and configured to execute any communication method described above.

In order to solve the above technical problem, a fifth aspect of the present disclosure provides a storage apparatus. The apparatus has program data stored therein, wherein the program data is executable to perform any communication method described above.

The present disclosure has the following advantages: compared with the related art, in the present disclosure, when the SCG failure occurs between the user equipment and the SCG, the measurement and/or reporting activities may be reduced, and thus the power/resource consumption consumed before the user equipment finds a proper cell can be reduced.

### BRIEF DESCRIPTION OF THE DRAWINGS

FIG. 1 is a flow chart of a first embodiment of a communication method of the present disclosure.

FIG. 2 is a flow chart of a second embodiment of a communication method of the present disclosure.

FIG. 3 is a flow chart of a third embodiment of a communication method of the present disclosure.

FIG. 4 is a flow chart of a fourth embodiment of a communication method of the present disclosure.

FIG. 5 is a flow chart of a fifth embodiment of a communication method of the present disclosure.

FIG. 6 is a flow chart of a sixth embodiment of a communication method of the present disclosure.

FIG. 7 is a block diagram illustrating the connection between the UE and the SN according to the communication method provided in the embodiments of the present disclosure.

FIG. 8 is a schematic view of an embodiment of a storage apparatus.

### DETAILED DESCRIPTION

The technical schemes in the embodiments of the present disclosure will now be described in conjunction with the accompanying drawings in the embodiments of the present disclosure, and it will be apparent that the described embodiments are merely parts of the embodiments of the disclosure, and are not all embodiments. All other embodiments obtained based on the embodiments in the present disclosure by those of ordinary skill in the art without making creative work are within the scope of the present disclosure.

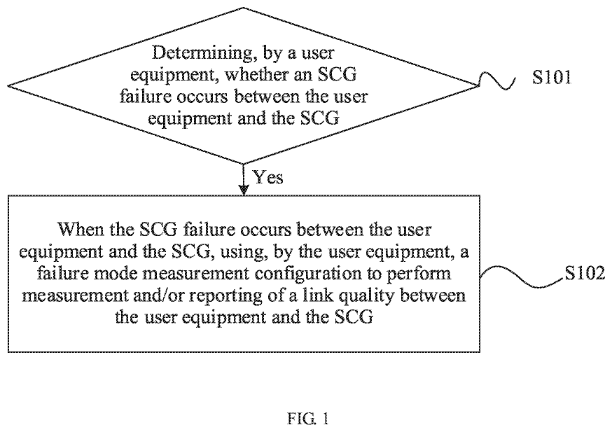

Referring to FIG. 1, a flow chart of a first embodiment of a communication method of the present disclosure is depicted. The communication method may include the following blocks.

At block S101: a UE may determine whether an SCG failure occurs between the UE and the SCG.

In a specific application scenario, the UE may be configured by a network to perform measurement of a link quality, and report the measurement to a secondary node (SN) currently communicating with the UE. The measurement may be on a cell level or a beam level. A measurement configuration may be informed to the UE via the SN currently communicating with the UE by means of dedicated signaling. After receiving the measurement configuration, the UE may read content included in the measurement configuration and perform the measurement and/or reporting.

In this application scenario, after receiving the measurement configuration from the SN, the UE may perform the measurement and/or reporting based on parameters in the measurement configuration, and meanwhile determine whether the SCG failure occurs between the UE and the SCG.

At block S102: when the SCG failure occurs between the UE and the SCG, the UE may activate a failure mode measurement configuration to perform the measurement and/or reporting of a link quality between the UE and the SCG.

In this application scenario, the measurement configuration received by the UE from the SN may include: a normal mode measurement configuration and a failure mode measurement configuration. The normal mode measurement configuration may refer to the measurement and/or reporting mode utilized by the UE when no SCG failure occurs or no SCG failure is detected during the communication. The failure mode measurement configuration may refer to the measurement and/or reporting mode utilized by the UE when the SCG failure is detected and the UE needs to find a proper cell and re-establish communication connection therewith promptly.

In this application scenario, the normal mode measurement configuration may include the following parameters.

(1) Measurement objects: a list of cells on which the UE may perform the measurement of the link quality. The network may configure specific lists of cells: a list of blacklisted cells and a list of whitelisted cells. The blacklisted cells are not applicable in the measurement and/or reporting, while the whitelisted cells are applicable in the measurement and/or reporting.

(2) Reporting configurations: each measurement object may have at least one reporting configuration. Each reporting configuration may include the following.

Reporting criterion: it refers to the criterion that triggers the UE to send a measurement report. The criterion may be periodical, or a single event description. According to agreements up to now, the events may at least include the following.

Event A1: Serving cell quality becomes better than an absolute threshold.

Event A2: Serving cell quality becomes worse than an absolute threshold.

Event A3: Neighbour cell quality becomes amount of offset better than primary secondary cell (PSCell) quality.

Event A4: Neighbour cell quality becomes better than an absolute threshold.

Event A5: PSCell quality becomes worse than a first absolute threshold, and neighbour cell quality becomes better than a second absolute threshold.

Event A6: Neighbour cell quality becomes amount of offset better than secondary cell (SCell) quality.

Reference Sign (RS) type: the RS type is the one that the UE may use for the measurement of the cell, such as new radio-synchronization signal (NR-SS) or channel state information-reference signal (CSI-RS).

Reporting format: it refers to the cell level and the beam level that the UE includes in the measurement report (e.g. reference signal receiving power (RSRP)) and associated information (e.g. the number of the cells and/or the beams to be reported).

(3) Measurement identities: each measurement identity links one measurement object with one reporting configuration. By configuring a plurality of measurement identities, it is possible to link more than one measurement object to the same reporting configuration. It is also possible to link more than one reporting configuration to the same measurement object.

(4) Quantity configurations: the quantity configurations define the quantity of the measurement and associated filtering used for all event evaluations and related reporting of the measurement type.

(5) Measurement gaps: periods that the UE may use to perform the measurement.

Based on TS 38.331, the information element (IE) reporting configuration (such as IE ReportConfigNR) configured for the reporting configuration may at least support two kinds of triggering methods to send reports: a periodical reporting method and an event-triggered periodical reporting method. In this application scenario, the normal mode measurement configuration may require the UE to send the report by using the periodical reporting method. In another application scenario, the normal mode measurement configuration may require the UE to send the report by using the method combining the event-triggered periodical reporting method with the periodical reporting method. That is, it is possible to send the measurement report by using both the event-triggered periodical reporting method and the periodical reporting method.

When the SCG failure occurs between the UE and the SCG, the UE may need to perform the measurement on the cells, in order to find the proper cell and re-establish communication connection promptly. However, if the cell quality is poor and the UE cannot find the proper cell to regain the communication connection for a long time, the continuation of periodical measurement and reporting based on the normal mode measurement configuration may be useless for the UE's connection establishment, and may cause a large amount of power/resource consumption.

Therefore, when the SCG failure occurs between the UE and the SCG, it needs to reduce the measurement and/or reporting activities of the link quality between the UE and the SCG, in order to reduce the power/resource consumption and save the power/resources. Accordingly, when the SCG failure between the UE and the SCG is detected by the UE, the UE may discard the normal mode measurement configuration for performing the measurement and/or reporting, and activate the failure mode measurement configuration included in the received measurement configuration, in order to reduce the measurement and/or reporting activities of the link quality between the UE and the SCG.

In this application scenario, the failure mode measurement configuration may no longer require the UE to send the measurement report by using the periodical reporting method. Instead, the failure mode measurement configuration may require the UE to send the measurement report by using the event-triggered periodical reporting method, in order to reduce the frequency of the measurement and/or reporting of the link quality between the UE and the SCG. The triggering event may be a specified event indicating that the cell quality becomes better than a preset condition. In the normal mode measurement configuration, if the measurement report is sent when the specified event indicating that the cell quality becomes better than the preset condition is triggered, and the measurement report is continuously sent even though the SCG failure occurs between the UE and the SCG, then it needs to stop sending the measurement report and reconfigure the measurement or reporting of the event based on the failure mode measurement configuration.

In addition, when the SCG failure occurs between the UE and the SCG, the UE is not able to connect to the SN. Therefore, in the failure mode measurement configuration, after triggered by the event, the UE may directly send an event-triggered report including the measurement result to a master Node (MN) communicating with the UE. In this way, the MN may send the content associated with the SN and included in the event-triggered report to the SN.

In this application scenario, the failure mode measurement configuration may include only the event A1 (serving cell quality becomes better than an absolute threshold) and the event A4 (neighbour cell quality becomes better than an absolute threshold). That is, in the failure mode measurement configuration, the UE may send the measurement report only when the event A1 and/or A4 is triggered, and will neither send the measurement report periodically, nor send the measurement report triggered by any one of other events A2, A3, A5 and A6, since only the events A1 and A4 are the specified events indicating that the cell quality becomes better than the preset condition. For example, the event A3 is triggered when the neighbour cell quality becomes amount of offset better than the PSCell quality. However, after the SCG failure occurs, the PSCell quality rapidly declines. Thus, being better than the PSCell is not enough to demonstrate that the neighbour cell is proper, and able to satisfy the preset condition and reach the threshold. Thus, in this application scenario, the UE may send the event-triggered report to the MN only when the event A1 and/or A4 is triggered.

In this application scenario, the failure mode measurement configuration may further include the following parameters.

Report quantity: the report quantity may be defined by a parameter corresponding to a report amount (reportAmount) in an IE reporting configuration (such as IE reportConfigNR).

Measurement period: a period that the UE may use to perform the measurement. The measurement period may be defined by a parameter corresponding to a measurement gap configuration (such as field measGapConfig) in a measurement configuration (such as IE MeasConfig), a SCell measurement period (such as field measCycleSCell) or a synchronization signal block measurement time configuration (such as field SSB-MeasurementTimingConfiguration) in a measurement object (such as IE MeasObjectNR).

Reporting period: a period that the UE may use to send the report based on the measurement result. The reporting period may be defined by a parameter corresponding to a reporting interval (such as field report Interval) in the reporting configuration (such as IE reportConfigNR).

In addition, the failure mode measurement configuration may further include other associated parameters. The associated parameters may be defined by parameters in the measurement objects (such as IE MeasObjectNR) and correspond to the scope of the cells included for measurement/reporting.

In this application scenario, the UE may send the report when it is triggered by the specified event indicating that the cell quality becomes better than the preset condition in the failure mode measurement configuration. However, in another application scenario, the UE may stop using the periodical reporting method, or stop sending the report triggered by the specified events A2, A3, A5 and A6 indicating that the cell has the link quality worse than the preset condition in the event-triggered periodical reporting method. Instead, the UE may only send the event-triggered report to the MN when it is triggered by the events A1 and A4.

In another application scenario, in the failure mode measurement configuration, the UE can not only send the measurement report when it is triggered by the specified event, but also extend the UE measurement period, in order to reduce the measurement and/or reporting of the link quality between the UE and the SCG.

In this embodiment, the SCG failure between the UE and the SCG may include: SN radio link failure (RLF), SN configuration failure, SN change failure, SN radio resource control (RRC) integrity check failure, and the like.

In this application scenario, the failure mode measurement configuration may be transmitted from the SN to the UE at the beginning of the communication. However, in another application scenario, the failure mode measurement configuration may also be transmitted from the MN to the UE after the MN receives the SCG failure information from the UE. In a further application scenario, it is also possible to preset and store the failure mode measurement configuration in the UE, and activate the pre-stored failure mode measurement configuration when the SCG failure between the UE and the SCG is detected.

It can be understood that, when the SCG failure occurs between the UE and the SCG, it is possible to reduce the power/resource consumption consumed before the UE finds the proper cell to establish the communication connection therewith by reducing the measurement and/or reporting activities of the link qualities between the UE and the SCG, and the power/resources may be effectively saved.

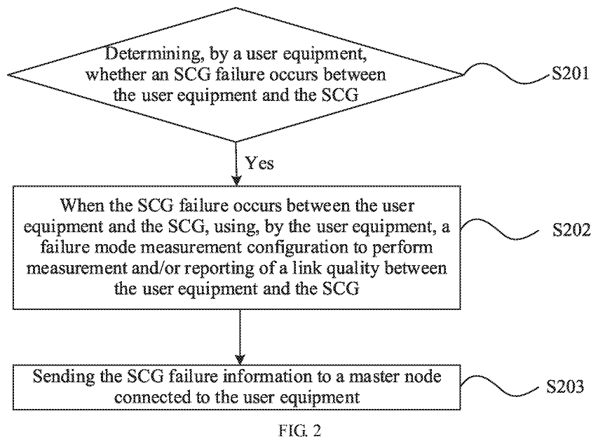

Referring to FIG. 2, a flow chart of a second embodiment of a communication method of the present disclosure is depicted. The communication method may include the following blocks.

At block S201: the UE may determine whether the SCG failure occurs between the UE and the SCG.

At block S202: when the SCG failure occurs between the UE and the SCG, the UE may reduce the measurement and/or reporting activities of the link quality between the UE and the SCG.

The blocks S201 and S202 in the second embodiment are similar to the blocks S101 and S102 provided in the communication method of the first embodiment, and will not be described in detail any more.

At block S203: the SCG failure information may be sent to the MN connected to the UE.

In a specific application scenario, when the SCG failure occurs, the UE is not able to connect to the SCell, and cannot communicate with the SN. At this time, the UE may send the SCG failure information to the MN connected to the UE. The SCG failure information may include the measurement result measured by the UE with respect to the SCG failure between the UE and the SCG. The MN may further send the content associated with the SN and included in the SCG failure information to the SN associated with the SCG or the SCG. In this way, the SN may acquire the specific content with respect to the SCG failure.

In this embodiment, the SN may be a new radio network node (gNB), an Evolved Node B (eNB), or a next generation Evolved Node B (ng-eNB). The MN may be the gNB, the eNB, or the ng-eNB. The MN may be connected to the SN via an X2 interface or an Xn interface. In this embodiment, the ng-eNB may be a protocol terminal configured to provide a user plane and a control plane for an Evolved-UMTS Terrestrial Radio Access (E-UTRA), and may be connected to a 5G core network via an NG interface. When the core network connected to the MN is a 4G core network, the MN may be connected to the SN via the X2 interface. When the core network connected to the MN is the 5G core network, the MN may be connected to the SN via the Xn interface.

It can be understood that, in this embodiment, the UE may send the SCG failure information to the MN connected to the UE. The SCG failure information may include the measurement result measured by the UE with respect to the SCG failure between the UE and the SCG. The MN may further send the content associated with the SN and included in the SCG failure information to the SCG or the SN associated with the SCG. In this way, the SN having the SCG failure may acquire the specific content with respect to the SCG failure.

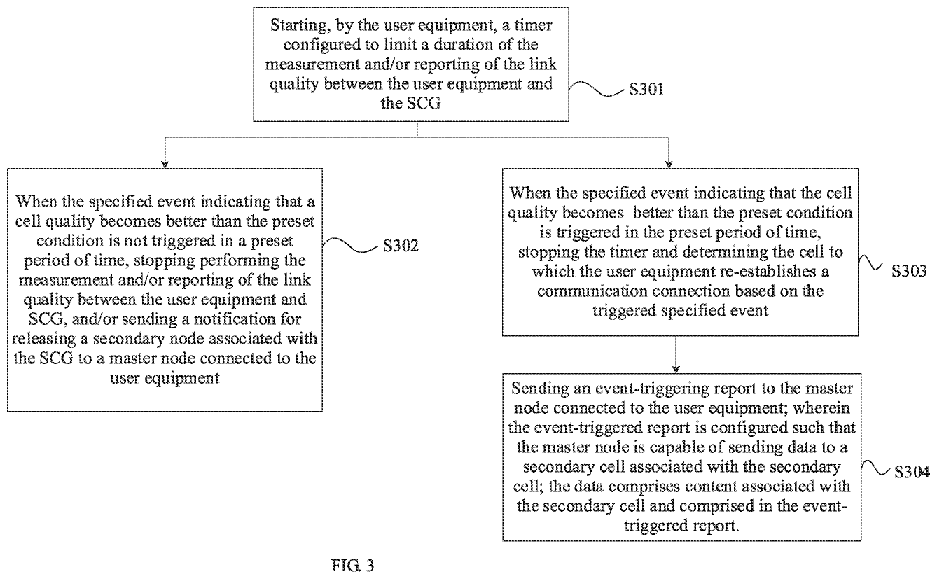

Referring to FIG. 3, a flow chart of a third embodiment of a communication method of the present disclosure is depicted. The communication method may include the following blocks.

At block S301: the UE may start a timer configured to limit a duration of the measurement and/or reporting of the link quality between the UE and the SCG.

In a specific application scenario, the UE may start the timer based on the measurement result and the detected SCG failure between the UE and the SCG. The timer may be configured to limit the duration of the measurement and/or reporting of the link quality between the UE and the SCG. Since the cell quality may stay being poor continually, the UE may not find the proper cell to re-establish the communication connection thereto for a very long time. In this application scenario, the UE may send the measurement report only when the specified event indicating that the cell quality becomes better than the preset condition is triggered. However, the UE may continue performing the measurement of the link quality of the cell. If the UE cannot find the proper cell, the UE will continue performing the measurement of the link quality of the cell. In an obvious case that the proper cell cannot be found, the continuation of the measurement and finding may cause a waste of power/resources. Thus, in this embodiment, the timer may be provided to limit the duration of the measurement and/or reporting of the link quality between the UE and the SCG.

At block S302: when the specified event indicating that the cell quality becomes better than the preset condition is not triggered in a preset period of time, the measurement and/or reporting of the link quality between the UE and the SCG may be stopped performing, and/or a notification for releasing the SN may be sent to the MN.

In a specific application scenario, if the specified event indicating that the cell quality becomes better than the preset condition is not triggered in the preset period of time, it indicates that the cell quality stays being poor, and the UE cannot find the proper cell. Therefore, the UE may stop the measurement and/or reporting of the link quality between the UE and SCG, in order to save the power/resources consumed during the measurement. In this embodiment, the SCG refer to the group of cells associated with the SN. In another application scenario, if the specified event indicating that the cell quality becomes better than the preset condition is not triggered in the preset period of time, it also indicates that the UE cannot connect to the SN previously connected to the UE, and thus the UE may choose to discard the SN and stop performing the measurement on the SN and the associated cell. Meanwhile, the UE may send a release request to the MN and inform the MN to release the SN, in order to further save the power/resources.

At block S303: when the specified event indicating that the cell quality becomes better than the preset condition is triggered in the preset period of time, the timer may be stopped and the cell with which the UE may re-establish the communication connection may be determined based on the triggered specified event.

In a specific application scenario, when the specified event indicating that the cell quality becomes better than the preset condition is triggered in the preset period of time, it indicates that the UE has already found the proper cell. Thus, the UE may stop the timer, and determine the cell with which the UE may re-establish the communication connection based on the triggered specified event. More specifically, when the event A1 is triggered, the UE may re-establish the communication connection to an original cell. However, when the event A4 is triggered, the UE may establish the communication connection to the neighbour cell. When the event A1 and A4 are triggered simultaneously, the UE may select the proper cell based on the measurement results respectively of the communication qualities of the original cell and the neighbour cell, or keep connecting to the original cell.

At block S304: the event-triggered report may be sent to the MN connected to the UE; wherein the event-triggered report may be configured in such a way that the MN may send data to the SN associated with the SCG. The data may include the content associated with the SN and included in the event-triggered report.

In a specific application scenario, when the specified event indicating that the cell quality becomes better than the preset condition is triggered in the preset period of time, the UE may send the event-triggered report to the MN connected to the UE based on the triggered event. The event-triggered report may include the measurement result. When the SCG failure occurs between the UE and the SCG, the UE is not able to connect to the SN, and cannot communicate with the SN. In this case, the UE may send the event-triggered report to the MN, and the MN may in turn send the content associated with the SN and included in the event-triggered report to the SN. Thus, the SN may acquire the content with respect to the SCG failure and the communication connection establishment between the UE and the proper cell.

In another application scenario, the timer may include a multistage timer. When each stage of the timer expires, the UE may correspondingly narrow a scope of the cells to be measured and/or reported, or extend the measurement periods or the report periods. The scope may be determined based on the distance between the cell and the UE; in this case, when the each stage of the timer expires, the cell having a further distance may be excluded. It is also possible to determine the scope based on the link quality of the cell acquired from the last measurement; in this case, when the each stage of the timer expires, the cell having a poorer link quality may be excluded. When the last stage of the timer expires, the measurement and/or reporting of the link quality between the UE and the SCG may be stopped.

In this embodiment, the duration of the timer may be set based on the average recovery time of the communication of the SCG, or may be directly set manually. The duration of the timer may also be set by the UE. After starting the timer, the UE may set the duration of the timer by itself, and perform the time-keeping based on the duration of the timer. In another application scenario, the duration of the timer may also be transmitted from the MN or the SN to the UE.

In this embodiment, the SN may be the gNB, the eNB, or the ng-eNB. The MN may be the gNB, the eNB, or the ng-eNB. The MN may be connected to the SN via the X2 interface or the Xn interface. In this embodiment, the ng-eNB may be a protocol terminal configured to provide a user plane and a control plane for the E-UTRA, and may be connected to the 5G core network via the NG interface. When the core network connected to the MN is the 4G core network, the MN may be connected to the SN via the X2 interface. When the core network connected to the MN is the 5G core network, the MN may be connected to the SN via the Xn interface.

It can be understood that, in this embodiment, when the SCG failure between the UE and the SCG is detected by the UE, the UE may start the timer to limit the duration of the measurement and/or reporting of the link quality between the UE and the SCG, in order to avoid the waste of power/resources caused by the continuation of the measurement and/or report when the proper cell cannot be found for a very long time.

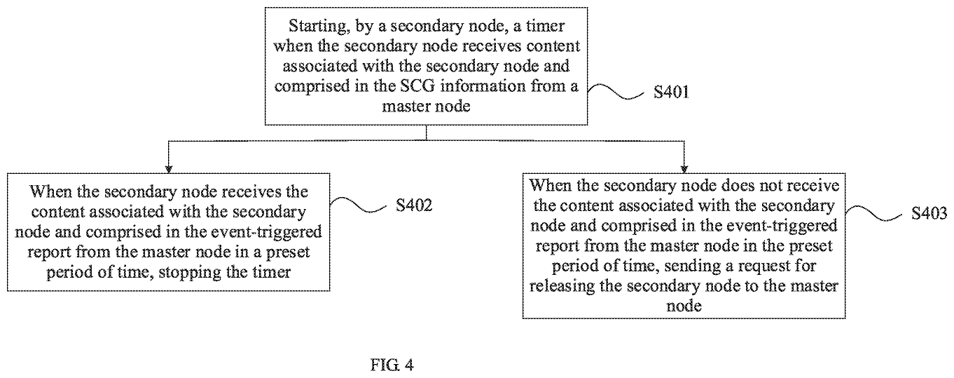

Referring to FIG. 4, a flow chart of a fourth embodiment of a communication method of the present disclosure is depicted. The communication method may include the following blocks.

At block S401: when receiving the content associated with the SN and included in the SCG failure information from the MN, the SN may start a timer.

In a specific application scenario, the SN may send the measurement configuration to the UE. The measurement configuration may be informed to the UE via the SN by means of the dedicated signaling. After receiving the measurement configuration, the UE may read the content included therein, and perform the measurement and/or reporting based on the measurement configuration. Meanwhile, the UE may determine whether the SCG failure occurs between the UE and the SCG based on measurement result. When the UE determines that the SCG failure occurs between the UE and the SCG, the UE is not able to connect to the SN, and cannot communicate with the SN. At this time, the UE may send the SCG failure information to the MN connected to the UE. The SCG failure information may include the measurement result measured by the UE with respect to the SCG failure between the UE and the SCG. After receiving the SCG failure information, the MN may further send the content associated with the SN and included in the SCG failure information to the SN.

In this application scenario, the measurement configuration transmitted from the SN to the UE may include: the normal mode measurement configuration and the failure mode measurement configuration. The normal mode measurement configuration may refer to the measurement and/or reporting mode utilized by the UE when no SCG failure occurs or no SCG failure is detected during the communication. The failure mode measurement configuration may refer to the measurement and/or reporting mode utilized by the UE when the SCG failure is detected and the UE needs to find the proper cell and re-establish the communication connection therewith promptly. In this application scenario, the failure mode measurement configuration may use the event-triggered periodical reporting method in order to reduce the frequency of measurement and/or reporting of the link quality between the UE and the SCG. The triggering event may be the specified event indicating that the cell quality becomes better than the preset condition. In this application scenario, in the failure mode measurement configuration, the UE may send the event-triggered report only when the event A1 (serving cell quality becomes better than an absolute threshold) and/or the event A4 (neighbour cell quality becomes better than an absolute threshold) is triggered.

When the UE is triggered by the specified event indicating that the cell quality becomes better than the preset condition, the UE may send the event-triggered report to the MN connected to the UE based on the specified event which is triggered. When the SCG failure occurs between the UE and the SCG, the UE is not able to connect to the SN, and cannot communicate with the SN. At this time, the UE may send the event-triggered report including the measurement result to the MN. The MN may further send the content associated with the SN and included in the event-triggered report to the SN. In this way, the SN may acquire the content with respect to the SCG failure and the communication connection establishment between the UE and the proper cell.

If the UE has not been triggered by the specified event indicating that the cell quality becomes better than the preset condition to send the report, it indicates that the UE cannot find the proper cell to establish the communication connection therewith all the time. However, the SN keeps waiting for the content associated with the SN and included in the event-triggered report from the MN, thereby resulting in a waste of power/resources. In addition, if the UE has not been triggered by the specified event indicating that the cell quality becomes better than the preset condition to send the report, it also indicates that the UE cannot establish the communication connection with the SN. In this case, the UE may choose to discard all the SNs, and stop performing the measurement on the SNs and associated cells. If the MN is not informed that the UE cannot establish the communication connection with the SN, the MN may keep communicating with the SN. However, since the SN cannot be used by the UE at this time, it may cause a waste of the communication power/resources.

Therefore, after the SN receives the content associated with the SN and included in the SCG failure information, the timer may be started. The timer may be configured to limit the wait time for the SN to receive the content associated with the SN and included in the event-triggered report from the MN.

At block S402: when receiving the content associated with the SN and included in the event-triggered report from the MN in the preset period of time, the SN may stop the timer.

In a specific application scenario, when the SN receives the content associated with the SN and included in the event-triggered report from the MN in the preset period of time, it indicates that the UE has already found the cell with which the UE may establish the communication connection. At this time, the SN may stop the timer, and read the content from the MN.

S403: When the SN does not receive the content associated with the SN and included in the event-triggered report from the MN in the preset period of time, a request for releasing the SN may be sent to the MN.

In a specific application scenario, if the SN does not receive the content associated with the SN and included in the event-triggered report from the MN in the preset period of time, it indicates that the UE cannot find the cell with which the UE may establish the communication connection in the preset period of time. That is to say, the cell quality stays being poor, and the UE cannot establish the communication connection to the SN. In this case, the UE may choose to discard the SN and stop performing the measurement on the SN and the associated cell. The SN may stop waiting to receive the content associated with the SN and included in the event-triggered report from the MN, inform and request the MN to release the SN and stop communicating with the SN.

In this embodiment, the SCG failure between the UE and the SCG may include: the SN RLF, the SN configuration failure, the SN change failure, the SN RRC integrity check failure, and the like.

In this embodiment, the duration of the timer may be set based on the average recovery time of the communication of SCG, or may be directly set manually. In another application scenario, the duration of the timer may also be transmitted from the MN to the SN.

In this embodiment, the SN may be the gNB, the eNB, or the ng-eNB. The MN may be the gNB, the eNB, or the ng-eNB. The MN may be connected to the SN via the X2 interface or the Xn interface. In this embodiment, the ng-eNB may be a protocol terminal configured to provide a user plane and a control plane for the E-UTRA, and may be connected to the 5G core network via the NG interface. When the SN is the gNB or the eNB, and the MN is the gNB or the eNB, the MN may be connected to the SN via the X2 interface. When the core network connected to the MN is the 4G core network, the MN may be connected to the SN via the X2 interface. When the core network connected to the MN is the 5G core network, the MN may be connected to the SN via the Xn interface.

It can be understood that, in this embodiment, after the SN receives the content associated with the SN and included in the SCG failure information from the MN, the SN may start the timer. In this way, it is possible to limit the wait time for the SN to receive the content associated with the SN and included in the event-triggered report from the MN. The SN may stop waiting for the content associated with the SN and included in the event-triggered report from the MN, and the MN may release the SN. In this way, the communication power/resources may be effectively saved.

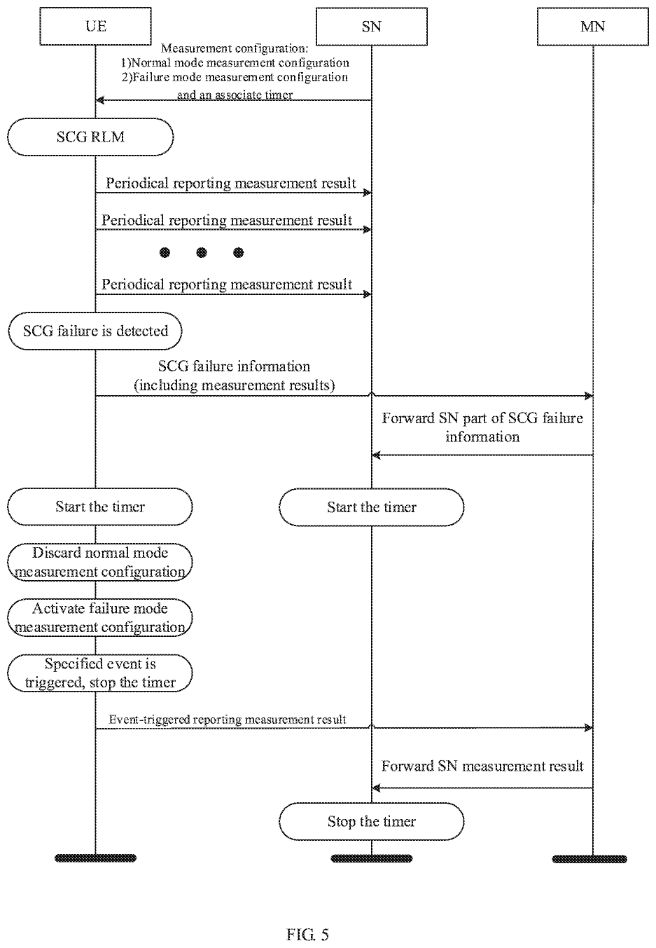

Referring to FIG. 5, a flow chart of a fifth embodiment of a communication method of the present disclosure is depicted. The communication method may include the following blocks.

The UE may receive the measurement configuration from the SN. Wherein the measurement configuration may be configured in such a way that the UE may perform the measurement and/or report of the link quality of the cell based on the measurement configuration. In this embodiment, the measurement configuration may include: the normal mode measurement configuration and the failure mode measurement configuration. The normal mode measurement configuration may refer to the measurement and/or reporting mode utilized by the UE when no SCG failure occurs or no SCG failure is detected during the communication. The failure mode measurement configuration may refer to the measurement and/or reporting mode utilized by the UE when the SCG failure is detected and the UE needs to find a proper cell and re-establish communication therewith promptly.

Based on TS 38.331, the IE ReportConfigNR of the reporting configurations may at least support two kinds of triggering methods to send the reports: the periodical reporting method and the event-triggered periodical reporting method. In this application scenario, the normal mode measurement configuration may require the UE to send the report by using the periodical reporting method. In another application scenario, the normal mode measurement configuration may require the UE to send the report by using the method combining the event-triggered periodical reporting method with the periodical reporting method. That is, it is possible to send the measurement report by using both the event-triggered periodical reporting method and the periodical reporting method. The failure mode measurement configuration may require the UE to send the measurement report only when the specified event indicating that the cell quality becomes better than the preset condition is triggered. In this application scenario, the UE may send the measurement report only when the event A1 (serving cell quality becomes better than an absolute threshold) and/or A4 (neighbour cell quality becomes better than an absolute threshold) is triggered, and will neither send the measurement report periodically, and nor send the measurement report triggered by any one of other events.

At a certain time, the SCG failure may occur between the UE and the SCG. Before the SCG failure is detected by the UE, the UE may use the periodical reporting method based on the normal mode measurement configuration. After that, when the UE determines that the SCG failure occurs between the UE and SCG, the UE is not able to connect to the SN, and cannot communicate with the SN. At this time, the UE may send the SCG failure information to the MN connected to the UE. The SCG failure information may include the measurement result measured by the UE with respect to the SCG failure occurring between the UE and the SCG. After receiving SCG failure information, the MN may further send the content associated with the SN and included in the SCG failure information to the SN.

Then, the UE may start the timer. The timer may be configured to limit the duration of the measurement and/or reporting of the link quality between the UE and the SCG. Since the cell quality may stay being poor continually for a very long time, the UE may not find the proper cell to re-establish the communication connection. In this application scenario, the UE may send the measurement report only when the specified event indicating that the cell quality becomes better than the preset condition is triggered. However, the UE may continue performing the measurement of the link quality of the cell. If the UE cannot find the proper cell, the UE will continue performing the measurement of the link quality of the cell. In an obvious case that the proper cell cannot be found, the continuation of finding may cause a waste of power/resources. Therefore, in this embodiment, the timer may be provided to limit the duration of the measurement and/or reporting of the link quality between the UE and the SCG. In this embodiment, the duration of the timer may be set based on the average recovery time of the communication of SCG, or may be directly set manually.

With the starting of the timer, the UE may discard the normal mode measurement configuration, and activate the failure mode measurement configuration instead. The UE may send the measurement report only when the specified event indicating that the cell quality becomes better than the preset condition is triggered. In a preset period of time, before the timer expires, if the specified event indicating that the cell quality becomes better than the preset condition is triggered, it indicates that the UE finds the proper cell to establish the communication connection. The UE may further send the event-triggered report to the MN connected to the UE based on the triggered event. When the SCG failure occurs between the UE and the SCG, the UE is not able to connect to the SN, and cannot communicate with the SN. In this case, the UE may send the event-triggered report to the MN, such that the MN may send the content associated with the SN and included in the event-triggered report to the SN. Thus, the SN may acquire the content with respect to the SCG failure and the communication connection establishment between the UE and the proper cell.

After receiving the content associated with the SN and included in the SCG failure information from the MN, the SN may start the timer. If the UE is not triggered by the specified event indicating that the cell quality becomes better than the preset condition to send the report, it indicates that the UE cannot find the proper cell to establish the communication connection therewith all the time. However, the SN keeps waiting for the content associated with the SN and included in the event-triggered report from the MN, thereby resulting in a waste of power/resources. In addition, if the UE is not triggered by the specified event indicating that the cell quality becomes better than the preset condition to send the report all the time, it also indicates that the UE cannot establish the communication connection with the SN all the time. In this case, the UE may choose to discard all the SNs, and stop performing the measurement on the SNs and associated cells. If the MN is not informed that the UE cannot establish the communication connection to the SN, the MN may keep communicating with the SN all the time. However, since the SN cannot be used by the UE at this time, it may cause a waste of the communication power/resources. Therefore, after receiving the content associated with the SN and included in the SCG failure information, the SN may start the timer. The timer may be configured to limit the wait time for the SN to receive the content associated with the SN and included in the event-triggered report from the MN. In this embodiment, the duration of the timer may be set based on the average recovery time of the communication of SCG, or may be directly set manually.

Optionally, it is not necessary for the duration of the timer set by the SN to be equal to that of the timer set by the UE, since the start time of the timer set by the SN is different from that of the timer set by the UE. The SN may start the timer after receiving the content associated with the SN and included in the SCG failure information from the MN, and the start time of the timer set by the SN may be slightly later than the start time of the timer of the UE. However, the duration of the timer set by the SN should correspond to the duration of the timer set by the UE and should be long enough, such that when the UE finds the proper cell and sends the event-triggered report to the MN and the MN further sends the content associated with the SN and included in the event-triggered report to the SN, the SN may still remain at the time-keeping stage, and may stop the timer based on the received content.

In this embodiment, the SN may be the gNB, the eNB, or the ng-eNB. The MN may be the gNB, the eNB, or the ng-eNB. The MN may be connected to the SN via the X2 interface or the Xn interface. In this embodiment, the ng-eNB may be a protocol terminal configured to provide a user plane and a control plane for the E-UTRA, and may be connected to the 5G core network via the NG interface. When the core network connected to the MN is the 4G core network, the MN may be connected to the SN via the X2 interface. When the core network connected to the MN is the 5G core network, the MN may be connected to the SN via the Xn interface.

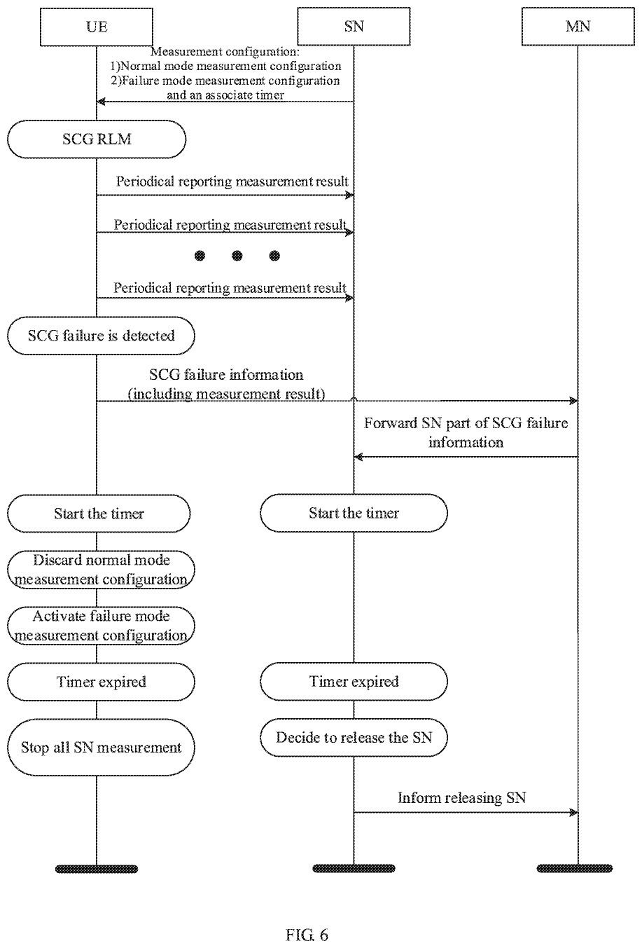

Referring to FIG. 6, a flow chart of a six embodiment of a communication method of the present disclosure is depicted. The communication method in this embodiment may include the following blocks.

In this embodiment, the blocks before the timers respectively set by the UE and the SN expire are the substantially same as those provided in the communication method of the fifth embodiment, and will not be described in detail any more.

When the timer set by the UE expires, that is to say, when the UE cannot find the proper cell to establish the communication connection therewith in the preset period of time, it indicates that the cell quality stays being poor continually. In this case, the UE may discard all the SNs and stop performing the measurement on the SN and the associated cell, in order to save the communication power/resources.

When the timer set by the SN expires, it also indicates that the cell quality stays being poor continually, and the SN cannot communicate with the UE. It will cause a waste of power/resources if the MN keeps communicating with the SN. Therefore, it may be decided to release the SN. Hence, the SN may send the release request to the MN, and the MN may release the SN.

In this application scenario, it is possible that the SN sends the release request to the MN. However, in another application scenario, it is also possible that the UE sends the release request to the MN after the timer set by the UE expires.

In this application scenario, the failure mode measurement configuration may be transmitted from the SN to the UE at the beginning of the communication. However, in another application scenario, the failure mode measurement configuration may be transmitted from the MN to the UE after the MN receives the SCG failure information from the UE. In a further application scenario, it is also possible to preset and store the failure mode measurement configuration in the UE, and activate the pre-stored failure mode measurement configuration when the SCG failure between the UE and the SCG is detected.

It can be understood that, in this embodiment, when the SCG failure occurs between the UE and the SCG, it is possible to reduce the power/resource consumption consumed before the UE finds the proper cell to establish the communication connection therewith by using the method of sending the measurement report only when the specified event indicating that the cell quality becomes better than the preset condition is triggered, and the power/resources may be effectively saved. In addition, both the UE and the SN may start the timer, in order to avoid the waste of power/resource caused by the continuation of the measurement or the communication when the cell quality stays being poor continually and the UE cannot find the proper cell.

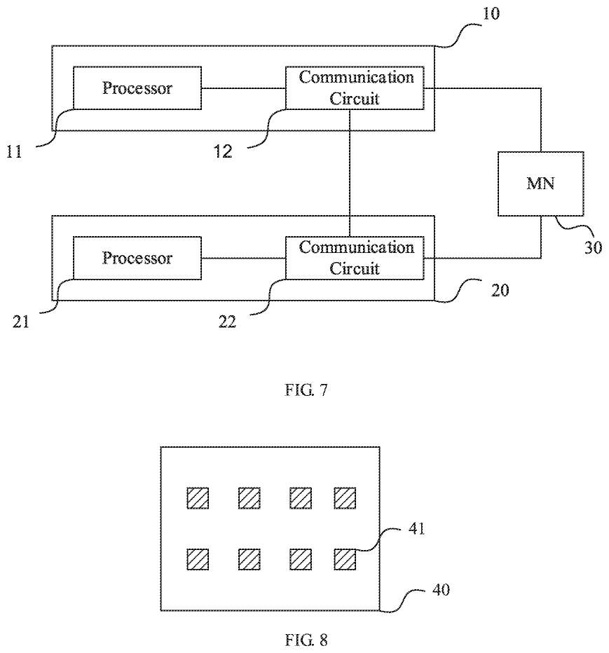

Referring to FIG. 7, a block diagram illustrating the connection between the UE and the SN according to the communication method of the present disclosure is depicted. The UE 10 may include a processor 11 and a communication circuit 12 coupled to the processor 11. The SN 20 may also include a processor 21 and a communication circuit 22 coupled to the processor 21. The communication circuit 12 may communicate with the communication circuit 22, and the communication circuit 12 and the communication circuit 22 may further communicate with the MN 30.

During the normal operation, the processor 21 of the SN 20 may control the communication circuit 22 to send the measurement configuration to the UE 10. The measurement configuration may be configured in such a way that the UE may perform the measurement and/or reporting of the link quality of the cell based on the measurement configuration. In this embodiment, the measurement configuration may include: the normal mode measurement configuration and the failure mode measurement configuration. The normal mode measurement configuration may refer to the measurement and/or reporting mode utilized by the UE when no SCG failure occurs or no SCG failure is detected during the communication. The failure mode measurement configuration may refer to the measurement and/or reporting mode utilized by the UE when the SCG failure is detected and the UE needs to find the proper cell and re-establish communication connection therewith promptly.

In this application scenario, the normal mode measurement configuration may require the UE 10 to send the report by using the periodical reporting method. In other application scenarios, the normal mode measurement configuration may require the UE 10 to send the report by using the method combining the event-triggered periodical reporting method with the periodical reporting method. That is to say, it is possible to send the measurement report by using both the event-triggered periodical reporting method and the periodical reporting method. The failure mode measurement configuration may require the UE 10 to send the measurement report only when the specified event indicating that the cell quality becomes better than the preset condition is triggered. In this application scenario, the processor 11 of the UE 10 may control the communication circuit 12 to send the measurement report only when the event A1 (serving cell quality becomes better than an absolute threshold) and/or A4 (neighbour cell quality becomes better than an absolute threshold) is triggered, and will neither send the measurement report periodically, and nor send the measurement report triggered by any one of other events.

The UE 10 may receive the measurement configuration via the communication circuit 12, and may perform the measurement and/or reporting based on the measurement configuration. The processor 11 may determine whether the SCG failure occurs between the UE and the SN 20. When the processor 11 determines that the SCG failure occurs, the communication circuit 12 of the UE 10 is not able to connect to the communication circuit 22 of the SN 20, and the UE 10 cannot communicate with the SN 20. At this time, the processor 11 of the UE 10 may control the communication circuit 12 to send the SCG failure information to the MN 30 connected to the UE 10. The SCG failure information may include the measurement result measured by the UE 10 with respect to the SCG failure occurring between the UE 10 and the SN 20. After receiving SCG failure information, the MN 30 may further send the content associated with the SN 20 and included in the SCG failure information to the SN 20. The SN 20 may receive the content via the communication circuit 22, the processor 21 may read the content and acquire the information associated with the SCG failure.

In another application scenario, it is possible to preset and store the failure mode measurement configuration in the UE 10, and activate the pre-stored failure mode measurement configuration when the SCG failure between the UE 10 and the SN 20 is detected by the UE 10. In a further application scenario, the failure mode measurement configuration may also be transmitted from the MN 30 to the UE 10 after the MN 30 receives the SCG failure information from the UE 10.

The processor 11 of the UE 10 may start the timer. The timer may be configured to limit the duration of the measurement and/or reporting of the link quality between the UE 10 and the SN 20. Since the cell quality may stay being poor for a very long time, the UE 10 may not find the proper cell to re-establish the communication connection therewith. In this application scenario, the processor 11 of the UE 10 may control the communication circuit 12 to send the measurement report only when the specified event indicating that the cell quality becomes better than the preset condition is triggered. If the UE 10 performs the measurement of the link quality of the cell periodically, and if the UE cannot find the proper cell in the environment, the UE 10 may continue performing the measurement of link quality of the cell. In an obvious case that the proper cell cannot be found, the continuation of the finding may cause a waste of power/resources. Thus, in this embodiment, the timer may be provided to limit the duration of the measurement and/or reporting of the link quality between the UE 10 and the cell. In this embodiment, the duration of the timer may be set based on the average recovery time of the communication of SCG, or may be directly set manually. The duration of the timer may be set by the UE 10, or may be transmitted from the SN 20 or the MN 30 to the UE 10.

With the starting of the timer, the processor 11 of the UE 10 may discard the normal mode measurement configuration, and use the failure mode measurement configuration instead. The processor 11 may control the communication circuit 12 to send the measurement report only when the specified event indicating that the cell quality becomes than the preset condition is triggered. In the preset period of time, before the timer expires, if the specified event indicating that the cell quality becomes better than the preset condition is triggered, it indicates that the UE 10 finds the proper cell to establish the communication connection. The processor 11 of the UE 10 may control the communication circuit 12 to send the event-triggered report to the MN 30 based on the triggered event. The MN 30 may further send the content associated with the SN 20 and included in the event-triggered report to the SN 20. The communication circuit 22 of the SN 20 may receive the content, the processor 21 may read the content, and acquire the content with respect to the SCG failure and the communication connection establishment between the UE and the proper cell.

After the communication circuit 22 of the SN 20 receives the content associated with the SN 20 and included in the SCG failure information from the MN 30, the timer may be started. If the UE 10 is not triggered by the specified event indicating that the cell quality becomes better than the preset condition to send the report, it indicates that the UE 10 cannot find the proper cell to establish the communication connection therewith all the time. However, the SN 20 keeps waiting for the content associated with the SN 20 and included in the event-triggered report from the MN 30, thereby resulting in the waste of power/resources. In addition, if the processor 11 of the UE 10 is not triggered by the specified event indicating that the cell has the link quality better than the preset condition to control the communication circuit 12 to send the report, it also indicates that the UE 10 cannot establish the communication connection with the SN 20 all the time. In this case, the UE 10 may choose to discard all the SNs, and stop performing the measurement on the SNs and associated cells. Besides, if the MN 30 is not informed that the UE cannot establish the communication connection with the SN 20, the MN 30 may keep communicating with the communication circuit 22 of the SN 20 all the time. However, since the SN 20 cannot be used by the UE 10 at this time, it may cause a waste of the communication power/resources. Therefore, after the communication circuit 22 of the SN 20 receives the content associated with the SN and included in the SCG failure information, the processor 21 may start the timer. The timer may be configured to limit the wait time for the SN 20 to receive the content associated with the SN and included in event-triggered report from the MN 30. In this embodiment, the duration of the timer may be set based on the average recovery time of the communication of SCG, or may be directly set manually. The duration of the timer may be preset and stored in the SN 20, set by the SN 20 itself, or transmitted from the MN 30 to the SN 20.

Optionally, it is not necessary for the duration of the timer set by the processor 21 of the SN 20 to be equal to that of the timer set by the processor 11 of the UE 10, since the start time of the timer set by the processor 21 of the SN 20 is different from that of the timer set by the processor 11 of the UE 10. The SN 20 may start the timer after receiving the content associated with the SN 20 and included in the SCG failure information from the MN, and the start time of the timer set by the processor 21 of the SN 20 may be slightly later than the start time of the timer of the processor 11 of the UE 10. However, the duration of the timer set by the processor 21 of the SN 20 should be long enough, such that when the UE 10 finds the proper cell and sends the event-triggered report to the MN 30, and the MN 30 further sends the content associated with the SN 20 and included in the event-triggered report to the SN 20, the SN may still remain at the time-keeping stage, and may stop the timer based on the received content.

In another application scenario, the UE 10 cannot find the proper cell. When the timer set by the UE 10 expires, it indicates that the cell quality stays being poor. In this case, the UE may discard all the SNs, and stop performing the measurement on the SN and the associated cell, in order to save the communication power/resources.

When the timer set by the SN 20 expires, it also indicates that the cell quality stays being poor, and the SN 20 cannot communicate with the UE 10. It will cause a waste of power/resources if the MN 30 keeps communicating with the SN 20. Therefore, it may be decided to release the SN 20. Hence, the SN 20 may send the release request to the MN 30, and the MN 30 release the SN 20.

In another application scenario, it is possible that the UE 10 sends the release request to the MN 30, and the MN further releases the SN 20.

It can be understood that, in this embodiment, when the SCG failure occurs between the UE and the SN, the UE may send the measurement report only when the specified event indicating that the cell quality becomes better than the preset condition is triggered. As a result, the communication power/resources may be effectively reduced. In addition, both the UE and the SN may be provided with the timers, in order to limit the duration of the measurement and/or reporting of the link quality of the cell, and prevent the waste of the communication power/resources caused by the SN continuously staying in the waiting state and keeping communicating with the MN.

Referring to FIG. 8, a schematic view of an embodiment of a storage apparatus is depicted. The storage apparatus 40 may have at least one program or instruction 41 stored therein. The program or instruction 41 may be configured to execute the communication methods shown in FIGS. 1-6. In one embodiment, the storage apparatus 40 may be implemented as a memory chip or a hard disk in the mobile terminal, or may be implemented as a readable storage medium such as a mobile hard disk, a USB disk, an optical disk, and the like. The storage apparatus 40 may also be implemented as a server and the like.

It can be understood that, in the embodiment, the program or instruction stored in the storage apparatus may be configured in such a way that the UE may send the measurement report only when the specified event indicating that the cell quality becomes better than the preset condition is triggered, when the SCG failure occurs between the UE and the SCG, in order to reduce the communication power/resource consumption. The UE and the SN may be both provided with the timers, in order to prevent the waste of the power/resource caused by the UE when the cell quality stays being poor, and the UE cannot find the proper cell and keeps performing the measurement or communication.

Compared with the related art in which the UE keeps using the original measurement and/or reporting method when the SCG failure occurs between the UE and the SCG, the UE disclosed in the embodiments of the present disclosure may send the measurement report only when the specified event indicating that the cell quality becomes better than the preset condition is triggered. Thus, it is possible to reduce the waste of the communication power/resources in the reporting before the UE finds the proper cell. The UE and the SN may both be provided with the timers, in order to limit the duration of the measurement and/or reporting of the link quality of the cell, and save the communication power/resources. It is also possible to avoid the waste of the power/resources caused by the SN continuously staying in the waiting state and keeping communicating with the MN.

The foregoing is merely embodiments of the present disclosure, and is not intended to limit the scope of the present disclosure. Any equivalent structure or flow transformation made based on the specification and the accompanying drawings of the present disclosure, or any direct or indirect applications of the present disclosure on other related fields, shall all be covered within the protection of the present disclosure.

1. A communication method for a scenario with a secondary cell group (SCG) failure, comprising:
determining, by a user equipment, whether the SCG failure occurs between the user equipment and the SCG;
when the SCG failure occurs between the user equipment and the SCG, using, by the user equipment, a failure mode measurement configuration to perform measurement and/or reporting of a link quality between the user equipment and the SCG.

2. The method of claim 1, wherein using the failure mode measurement configuration to perform the measurement and/or reporting of the link quality between the user equipment and the SCG comprises:
sending a measurement report only when a first specified event indicating that a cell quality becomes better than a preset condition is triggered; and/or
stopping performing the reporting of the link quality between the user equipment and the SCG periodically, and stopping sending the measurement report triggered by a second specified event indicating that the cell quality becomes worse than the preset condition; and/or
extending a measurement period of the link quality between the user equipment and the SCG;
the failure mode measurement configuration comprises: the measurement period, a report period, and a report quantity.

3. The method of claim 2, wherein the measurement period in the failure mode measurement configuration is defined by a parameter corresponding to a measurement gap configuration in a measurement configuration, a secondary cell measurement period or a synchronization signal block measurement time configuration in a measurement object;
the report period in the failure mode measurement configuration is defined by a parameter corresponding to a reporting interval in a reporting configuration;
the report quantity in the failure mode measurement configuration is defined by a parameter corresponding to a report amount in the reporting configuration.

4. The method of claim 3, wherein the measurement periods in the failure mode measurement configuration is defined by a parameter corresponding to a field measGapConfig in an information element (IE) MeasConfig, a field measCycleSCell or a field SSB-MeasurementTimingConfiguration in an IE MeasObjectNR;
the report period in the failure mode measurement configuration is defined by a parameter corresponding to a field reportInterval in an IE reportConfigNR;
the report quantity in the failure mode measurement configuration is defined by a parameter corresponding to a field reportAmount in the IE reportConfigNR.

5. The method of claim 2, wherein the first specified event indicating that the cell quality becomes better than the preset condition comprises:
a serving cell quality becomes better than a first absolute threshold; and/or
a neighbour cell quality becomes better than a second absolute threshold.

6. The method of claim 1, when the SCG failure occurs between the user equipment and the SCG, further comprising:
starting, by the user equipment, a timer configured to limit a duration of the measurement and/or reporting of the link quality between the user equipment and the SCG.

7. The method of claim 6, further comprising:
when a first specified event indicating that a cell quality better than the preset condition is not triggered in a preset period of time, stopping performing the measurement and/or reporting of the link quality between the user equipment and the SCG, and/or sending a notification for releasing a secondary node associated with SCG to a master node connected to the user equipment.

8. The method of claim 7, further comprising:
when the first specified event indicating that the cell quality becomes better than the preset condition is triggered in the preset period of time, stopping the timer and determining the cell with which the user equipment re-establishes a communication connection based on the first specified event which is triggered.

9. The method of claim 8, when the first specified event indicating that the cell quality becomes better than the preset condition is triggered in the preset period of time, further comprising:
sending an event-triggered report to the master node; wherein the event-triggered report is configured in such a way that the master node is capable of sending data to the secondary cell; the data comprises content associated with the secondary cell and comprised in the event-triggered report.

10. The method of claim 7, wherein the secondary node comprises a new radio network node (gNB), an Evolved Node B (eNB), or a next generation Evolved Node B (ng-eNB); or
the master node comprises a gNB, an eNB, or a ng-eNB; or
the master node is connected to the secondary node via an X2 interface or an Xn interface.

11. The method of claim 6, wherein a duration of the timer is set based on an average recovery time of the communication of the SCG, or directly set manually.

12. The method of claim 6, wherein a duration of the timer is set by the user equipment, or transmitted from the master node or the secondary node to the user equipment.

13. The method of claim 6, wherein the timer comprises a multistage timer;
when each stage of the multistage timer expires, the user equipment narrows a scope of the cells to be measured and/or reported, or extends the measurement periods or the report periods;
when the last stage of the multistage timer expires, the measurement and/or reporting of the link quality between the user equipment and the SCG is stopped.

14. The method of claim 1, when the SCG failure occurs between the user equipment and the SCG, further comprising:
stopping using an original measurement configuration, regardless of whether the measurement and/or reporting of the link quality between the user equipment and the SCG is being performed by using the original measurement configuration.

15. The method of claim 1, when the SCG failure occurs between the user equipment and the SCG, further comprising:
sending SCG failure information to the master node connected to the user equipment; wherein the SCG failure information is configured in such a way that the master node is capable of sending data to the secondary node associated with the secondary cell; the data comprises content associated with the secondary cell and comprised in the SCG failure information.

16. The method of claim 1, wherein the failure mode measurement configuration is pre-transmitted from the secondary node to the user equipment.

17. The method of claim 1, wherein the failure mode measurement configuration is transmitted from the master node to the user equipment after the master node receives the SCG failure information.

18. The method of claim 1, when the SCG failure does not occur between the user equipment and the SCG, the user equipment keeps performing the measurement and/or reporting of the link quality between the user equipment and the SCG by using the original measurement configuration.

19. A communication method, comprising:
starting, by a secondary node, a timer when the secondary node receives content associated with the secondary node and comprised in SCG failure information from a master node; wherein the timer is configured to limit wait time for the secondary node to receive content associated with the secondary node and comprised in the event-triggered report from the master node;
when the secondary node receives the content associated with the secondary node and comprised in the event-triggered report from the master node in a preset period of time, stopping the timer.

20. The method of claim 19, further comprising:
when the secondary node does not receive the content associated with the secondary node and comprised in the event-triggered report from the master node in the preset period of time, sending a request for releasing the secondary node to the master node.

21. The method of claim 19, wherein the SCG failure information is transmitted from a user equipment to the master node when an SCG failure between the user equipment and an SCG associated with the secondary node is detected by the user equipment.

22. The method of claim 19, wherein the event-triggered report is transmitted from the user equipment to the master node when a specified event indicating that a cell quality becomes better than a preset condition is triggered.

23. The method of claim 22, wherein the specified event indicating that the cell quality becomes better than the preset condition comprises:
a serving cell has a link quality better than a first absolute threshold; and/or
a neighbour cell has a link quality better than a second absolute threshold.

24. The method of claim 19, wherein the secondary cell comprises a gNB, a eNB, or a ng-eNB; or
the master node comprises a gNB, a eNB, or a ng-eNB; or
the master node is connected to the secondary cell via an X2 interface or an Xn interface.

25. The method of claim 19, wherein a duration of the timer is set based on an average recovery time of the communication of the SCG, or directly set manually.

26. The method of claim 19, wherein a duration of the timer is set corresponding to a duration of a timer started when an SCG failure between a user equipment and an SCG associated with the secondary node is detected by the user equipment.

27. A user equipment, comprising a processor and a communication circuit; wherein the processor is coupled to the communication circuit, and configured to execute the communication method of claim 1.

28. A communication node, comprising a processor and a communication circuit; wherein the processor is coupled to the communication circuit, and configured to execute the communication method of claim 19.

29. A storage apparatus, comprising program data stored therein, wherein the program data is executable to perform the method of claim 1.
